(19) United States
(12) Patent Application Publication
(10) Pub. No.: US 2019/0289790 A1
(43) Pub. Date: Sep. 26, 2019

(54) GAS DELIVERY SYSTEMS FOR CANNABIS AND OTHER CROPS, INCLUDING GAS WANDS AND MOBILE GAS CANOPYS

(71) Applicant: THE AGRICULTURAL GAS COMPANY, Petaluma, CA (US)

(72) Inventor: Stewart E. Erickson, Petaluma, CA (US)

(21) Appl. No.: 16/362,357

(22) Filed: Mar. 22, 2019

Related U.S. Application Data
(60) Provisional application No. 62/646,439, filed on Mar. 22, 2018.

(51) Int. Cl. A01G 7/02; A01G 9/24; A01G 9/18

(52) U.S. Cl. CPC A01G 7/02; A01G 22/00; A01G 9/18; A01G 9/24

(57) ABSTRACT

An agricultural gas wand system for distributing gas to a plant set including at least two supports adapted to be place adjacent the plant set, at least one elongated gas wand that engages two supports so that it is supported, adjustably with respect to height, adjacent the plant set, the at least one gas emission wand having a tubular body with a gas transmission lumen and at least one gas emitter element disposed on or in the body for egress of gas from the gas transmission lumen to the environment adjacent the plant set. Also disclosed is an agricultural gas canopy system including an elongated vertical support placed in close proximity to the plant set, and emitter array selectively coupleable to the support so that it is supported, adjustably with respect to height, above the plant. Also disclosed is a mobile gas canopy system for distributing gas to plants growing in rows including a movable gas canopy for enclosing a row of plants and along a length of the row, the canopy having a height which is greater than the height of the plants and a predetermined width which is greater than the width of the row defining an interior space for enclosing the plants, the canopy having an entrance end and an exit end which permit movement of the canopy along the row, and a gas supply for adding gas to the interior space.

### CROSS-REFERENCE TO RELATED APPLICATIONS, IF ANY

This application claims the benefit under 35 U.S.C. § 119(e) of co-pending U.S. Provisional Patent Application Ser. No. 62/646,439, filed Mar. 22, 2018, which is hereby incorporated by reference.

### 37 C.F.R. § 1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present invention relates, generally, to agricultural systems, apparatus and methods. Particularly, the invention relates to a system of delivering gases such as CO₂, Nitrogen, or other gases to crops. Most particularly, the invention relates to an integrated gas delivery systems for crops, most particularly Cannabis.

### 2. Background Information

Outdoor crop production tends to be grown in very long rows up to a quarter section long generally 1320 feet long (¼ mile), with some being much longer providing the overall bed length for planting of crops such as Cannabis. Long beds of Cannabis and other crops of this configuration are also planted in greenhouses or hoop houses.

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides an agricultural system, apparatus, and method which are beneficial, practical, reliable, and efficient, and which are believed to fulfill the need and to constitute an improvement over the background technology.

In one aspect, the invention provides an agricultural gas wand system for distributing gas to a plant set having one or more plants, comprising at least two supports adapted to be place adjacent the plant set, at least one elongated gas wand having a predetermined length such that it engages two supports so that it is supported, adjustably with respect to height, adjacent the plant set, the at least one gas emission wand having a tubular body with a gas transmission lumen and at least one gas emitter element disposed on or in the body for egress of gas from the gas transmission lumen to the environment adjacent the plant set.

In another aspect, the invention provides an agricultural gas canopy system for distributing gas to a plant set having one or more plants, comprising an elongated vertical support having a predetermined height and adapted to be placed in close proximity to the plant set, an emitter array selectively coupleable to the support so that it is supported, adjustably with respect to height, above the plant set, the emitter array having a base which engages the support and a plurality of arms which extend radially away from the base, the base and the arms each having a coextensive gas transmission lumen, each arm having at least one gas emitter element which is communicatively connected to the gas transmission element for egress of gas from the gas transmission lumen to the environment adjacent the plant set.

In a further aspect, the invention provides an agricultural mobile gas canopy system for distributing gas to a plurality of plants growing in rows, comprising an movable gas canopy for isolating and enclosing at least one row of plants and along a predetermined length of the at least one row of plants, the canopy having a predetermined height which is greater than the height of the plants and a predetermined width which is greater than the width of the row defining an interior space for enclosing the plurality of plants, the canopy having an entrance end and an exit end which permit unencumbered movement of the canopy along the row and in close proximity thereto, and a gas supply means for supplying gas to the interior space.

All of the aspects of the invention herein are optimized for use with CO2 gas around the leafy canopy of Cannabis for growth promotion and/or pest control.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a top or plan view of an embodiment of a gas distribution system of the present invention, including one or more gas wands.

FIG. 2 is a side elevation view of the gas wand system, showing a first state arranged with juvenile plants.

FIG. 3 is a side elevation view of the gas wand system, showing a second state arranged where the plants are mature and plural wands are elevated.

FIG. 4 is a perspective view of another embodiment of a gas distribution system of the invention, including one or more gas crescents, the system being deployed with one or more plants in a juvenile state.

FIG. 5 is a perspective view of the gas crescent system wherein the system has been elevated to optimize utility with the mature plant or plants.

FIG. 6 is a perspective view of an embodiment of a swivel nozzle which is useable with the gas distribution apparatus described herein.

FIG. 7 illustrates, in perspective, an embodiment of a multi-stage gas distribution system deployed in a hoop house environment.

FIG. 8 is an elevation view of the multi-stage gas emitter arrangement in the system of FIG. 7.

FIG. 9 illustrates an embodiment of an arc or crescent type gas emitter.

FIG. 10 illustrates an embodiment of a connector for use between emitter segments or sections in the arc type gas emitter.

FIG. 11 is a detailed view of an emitter segment taken at line 11-11 of FIG. 9.

FIG. 12 is a crossectional illustration of an embodiment of a molded crescent emitter section with flow restrictor features.

FIG. 13 is an end view of the emitter section shown in FIG. 12.

FIG. 14 is a detailed view of an embodiment of channels ion the emitter outlet.

FIG. 15 is a further detailed view of the channels.

FIG. 16 illustrates an embodiment of a mobile gas canopy system of the present invention, including a tractor, a gas supply trailer, and a long, unitary, gas canopy trailer.

FIG. 17 is a perspective view of a front entrance end of the trailer of the mobile gas canopy system.

FIG. 18 is a perspective view of the rear exit end of another embodiment of the mobile gas canopy trailer.

FIG. 19 illustrates another embodiment of the mobile gas canopy system, in side elevation, including a tractor pulling a gas supply trailer, and shorter gas canopy trailer.

FIG. 20 illustrates a further embodiment of the mobile gas canopy system, in side elevation, including a tractor, a gas supply trailer, and a multi segment gas canopy trailer.

FIG. 21 illustrates the system embodiment of FIG. 20, in perspective, in operation in a sloping field of crops.

FIG. 22 illustrates a further embodiment of the system, deployed on a relatively flat field of crops, and including a temporary flexible canopy disposed over rows of crops using stanchions, support cables/ropes engaging the stations, and deployable flexible canopy.

FIG. 23 is a perspective view of the system of FIG. 22.

FIG. 24 is a detailed view of a portion of the system of FIG. 23.

FIG. 25 illustrates yet a further embodiment of the system deployed in a vineyard, including sloping terrain.

FIG. 26 is a perspective view of an end of the system of FIG. 25.

### DETAILED DESCRIPTION

1. Gas Wand System and Methods

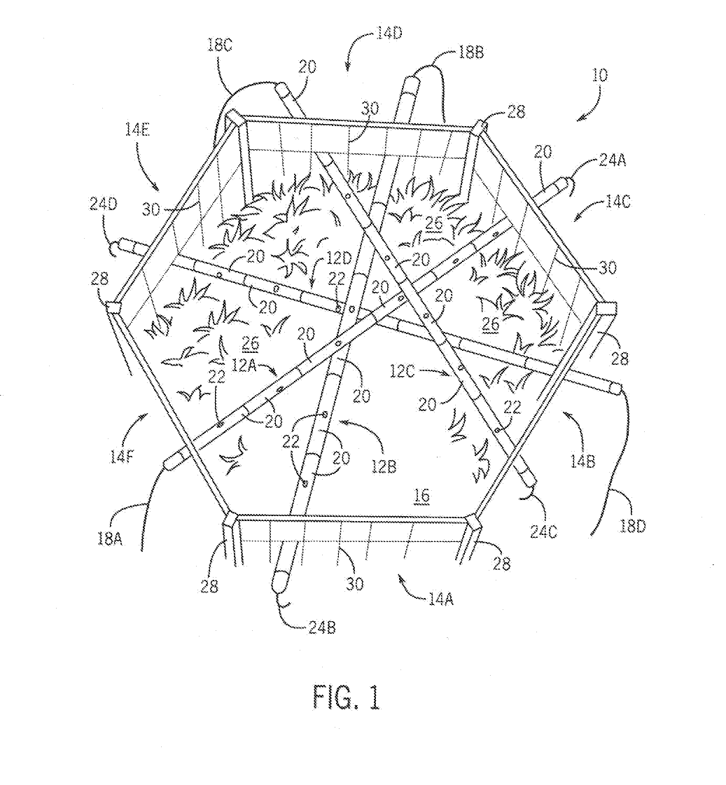

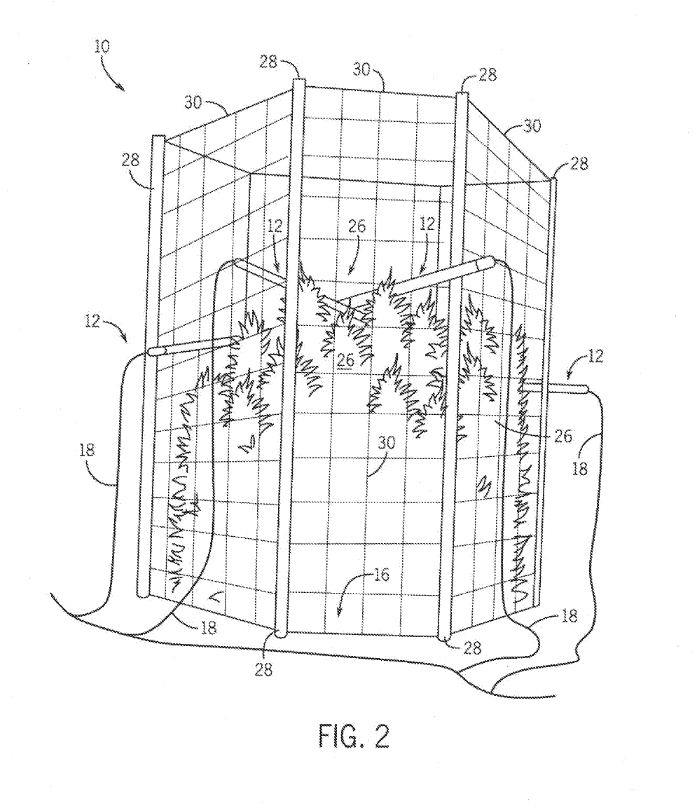

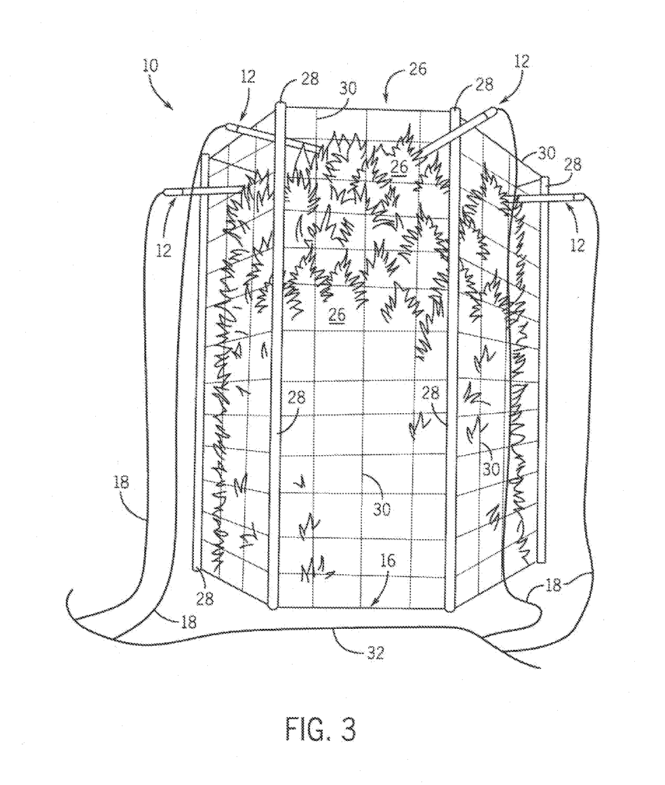

The invention provides a gas distribution system for applying gases such as Carbon Dioxide (CO2 or CO₂) to plants, particular crop plants, and most particular Cannabis. Referring to FIGS. 1-3, one embodiment of the invention comprises a wand apparatus 10 including one or more elongated wand emitter appliances 12. The wands 12A-D, in this embodiment four (4), are supported in a substantially horizontal position by two or more trellis 14. Preferably, three or more trellis 14 encircles a plant 26 or group of plants growing in ground or a soil bed. In the embodiment shown, six (6) trellis 14A-F are arranged to form a hexagon around a central plant area 16. Each wand appliance 12 is coupled or tethered to a flexible gas supply line 18. The coupling is preferably downwardly depending to prevent supply hose kinking. The supplies lines 18 are communicatively connected to a central supply 32. The supply lines 18 may be activated in sequence during a growing season to match gas flow to the size of the plants, beginning with a low flow early in a season and increasing flow later. The wand appliances 12 are preferably tubular and rigid or semi rigid, with an internal lumen for transportation of gas. The appliances 12 are elongated and have lengths from 1 to 12 feet. Most preferably they are from two to six feet in length. The appliances 12 are preferably constructed of interconnected modules, segments or sections 20 which are conjoined to each other, to form a longer device 12. For example, starting with an 18 inch wand of gas release and interconnecting creating up to a six foot long wand as the plant 26 grows larger. Modular construction also permits adjustment of the length of the wands 12 for use with variable trellis 14 diameters and plant arrangements, and also to maintain coverage of plants and they grow Each section 20 has at least one emitter element 22 for egress of gas. The elements 22 are preferably downwardly oriented during use. The emitter elements 22 may be apertures disposed in the wands 12 communicating the internal lumen of the wand 12 with the outside environment. Alternatively, they may be constructed in the form of a nozzle attached to the wands 12. The emission elements 22 are preferably adjustable along the length of the wand 12 and have on/off capability to modulate gas flow and mirror plant size. In non-modular wands, the apertures or nozzles are spaced at predetermined points along the length of the tubular wand body. Desirably, a connecter, preferably a hook 24, is provided on at least the distal end of the wand 12 to engage a trellis 14, the plant(s) 26 itself, or other desirable point of affixation. The hooks 24 preferably have a downward crook angle for suspension of the wand 12 in a lowered position below the hooks, to prevent the wands 12 from rolling and becoming dislodged. The trellis 14 is preferably constructed of one or more stands 28 and a section of mesh 30. The stands 28 are preferably posts which are embedded in the soil. Alternatively the stands 28 may be free standing. As shown, the mesh 30 is provided in a panel arrangement extending between two adjacent posts 28. Alternatively, the mesh 30 may be a continuous section that extends across more than two posts 28. The mesh 30 is preferably constructed of a polymeric material (for example plastic netting), but may be constructed of a metal material.

The wands 12 are suspended just at or above the leafy canopy of a single plant or group of plants 26. Preferably, a small downward crook is implanted between the hook point and wand so that the wand is suspended just below the receiver point to reduce rolling and displacement of the wand from its intended placement. Alternatively, the wands may be disposed above a row of crops. The wands 12 are moved up the trellis 14 as the plants 26 grow. Upward mobility and repositioning of the devices 12 is routinely performed based on rate of growth to correspond to plant growth, for example on a daily, weekly or monthly basis.

Desirably the wands 12 are of a length to extend across the diameter and sidewalls of mesh 30 that surround the plant(s) 26. The mesh 30 is preferably of a type commonly known and used in the industry of cannabis production. The wands 12 are introduced in such a manner that they are supported in a generally horizontal position resting on both ends in the mesh structure 30, in a desirable position just at or above the top of the plant 26. One or more wands 12 can be introduced into a single plant or group of plants 26 contained within the mesh 30, depending on the size of the plant 26 and desired delivery. The units 12 are easily removed or move out of the way to facilitate harvest and other agronomic functions like the introduction of mesh 30.

Alternatively, the wands 12 can be affixed to a stake (for example a stand or post 28) located within reach of the plants 26 canopy. A slider sleeve (not shown) can be provided around the stake 28, to afford easy vertical elevating and repositioning of the emitter array 12. In still another deployment, the long wands 12 can be suspended over the plant on a tether from an overhead structure. Whichever the support and deployment configuration for the wands 12, they are systematically elevated as the plant 26 grows, to maintain close proximity to the plant 26 canopy. They may be removed or moved out of the way to facilitate harvest and other agronomic functions like the introduction of mesh 30.

The invention can be extended to the control of pests such as Russet mites—Aceria anthocoptes, Spider mites or Broad mites, also known as Polyphagotarsonemus latus, (these mites are not actually true insects, but are arachnids), aphids, whiteflies, (VMB) vine mealybug—Planococcus ficus, (BMSB) brown marmorated stink bug, Glassy-winged sharpshooters, European grapevine moth (EGVM) and light brown apple moth (LBAM), and other leaf miners, boarer varieties, caterpillars and the likes, and other economically damaging insect pest species The infested plants are tented with a sealed plastic fabric cover and the gas is introduced for a period of around 15 to 60 minutes at greater than 10,000 ppm CO2 or greater than 25% reduced Oxygen content to kill all of the pests on the plants 26. Multiple plants 26 in that garden can be tented at once and a whole group can be cleansed of pest at once wither through a single tent or multiple tents hooked together with a manifold of houses. Canopy deployment can desirably occur at night and when it's not too hot and sunny out so as to terminally cook the plants. Use at night is further preferred, as desirable insects such as pollinators like honeybees have gone home to their hives for the night and would not thusly be exposed. Further, night time use is desirable because the plants are respiring, versus during the day when the plants are undergoing their photosynthetic process. In the case of a crop like mandarin oranges, use the same machine that is used to deploy the mesh nets can be used to deploy the plastic covers. Then turn on the gas, organically kill the pests, and remove the plastic cover. Current practices with mandarin oranges and other crops that use pollinator netting, the Pest Control Managers have no practical way to control pest with toxic spray chemicals during the 4 to 12-week deployment of the mesh netting over the crop, which the current invention we provide a suitable remedy for. And simply, the more desirable environmentally benign gas can penetrate and kill pests in areas on many crops, that toxic spray chemicals do not access. And the gas does not exhibit residual resdiency on the human consumed product, like toxic spray chemicals.

The system may incorporate a multi-media irrigation technology provided by The Agricultural Gas Company (AgGas) of Petaluma, Calif. USA (disclosed in U.S. patent application Ser. No. 15/731,221, hereby incorporated by reference) to accommodate conductance of a variety of liquids, gases, aerosols, volumes and flow rates. Gaseous conductance can include thermally treated air, such as cooled air drawn across an ambient vaporizer present, and reverse flow direction for odor control and humidity control practices.

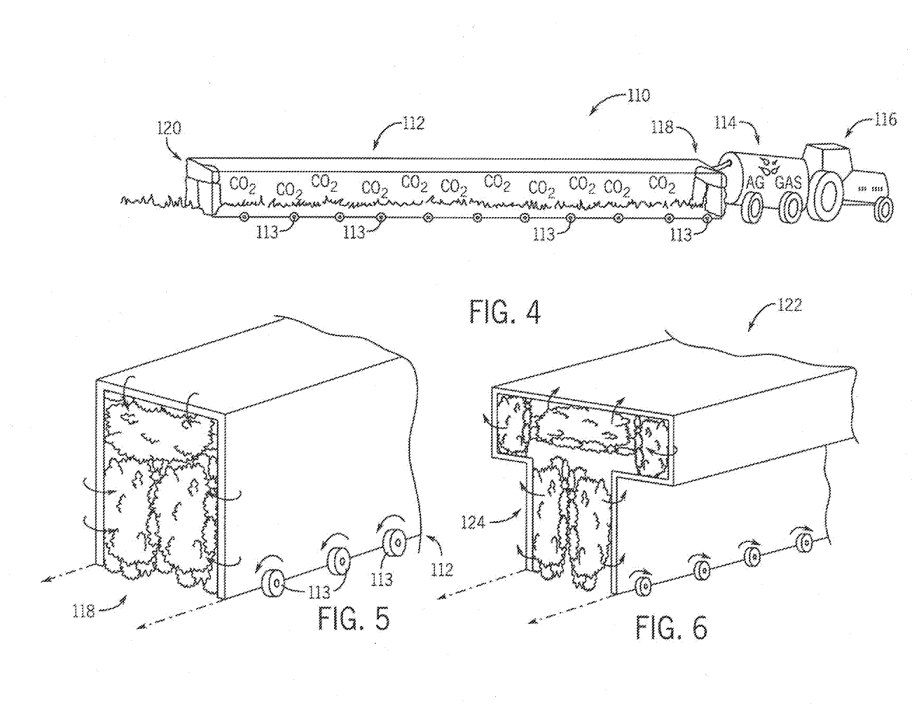

FIGS. 4 and 5 show another embodiment of the gas distribution system 40 for applying Carbon Dioxide (CO2) and/or other gasses to plants such as Cannabis. The system 40 includes a central stand 42, an emitter array 44, and a supply line 46. The stand 42 is preferably a post embedded in ground, a bed of soil, or a pot of soil containing one or more plants 26. It is rigid, elongated and has a predetermined length such that its top extends above the mature height of the mature plant that is intended to deliver gas to by four to twelve feet. The stand 42 is constructed of metal, but may be constructed of plastic or wood. A preferred embodiment is a metal T-Post with a PVC slider sleeve. The emitter array 44 is constructed and arranged to have a curvilinear canopy or umbrella-like configuration, with a central base 48 and at least two (preferably four (4)) curvilinear, downwardly sloping arc or crescent-like arms 50 A-D. The base 48 is adjustably coupled to the stand 42. The base 48 has a central gas transportation lumen that communicatively connects with the supply line 46 and a lumen of each arm 50. Arms 50 have a length such that they extend outwardly and downwardly over the canopy of the mature subject plant 26. The arc efficiently conforms to the perimeter of the plant foliage. In the embodiment shown, the array 44 has a height “A” between 1 and 15 feet, and a diameter “B” between 1 and 7 feet. The arms 50 have a length “C” between two and six feet. Arms 50 are preferably constructed of interconnected modules, segments or sections 54 which are conjoined to each other, to form the full arm 50. Each section 54 has at least one emitter element 56 for egress of gas. The emitter elements 56 may be apertures disposed in the arms 50 communicating the internal lumen of the arm 50 with the outside environment. Alternatively, they may be constructed in the form of a nozzle attached to the arms 50. In non-modular wands, the apertures or nozzles are spaced at predetermined points along the length of the tubular wand body. A terminal member 58 is attached to the distal ends of the arms 50. The system 40 is raised as plants 26 mature from plantings, juvenile (FIG. 4), and mature (FIG. 5) stage. At harvest, the system 40 is easily moved upwardly or sidewardly out the way, or removed entirely. The system 40 may then be quickly re-deployed for a new crop planting. Although the array 44 has a preferred form of an arc, it is within the purview of the invention that it could be constructed in the form of a circular hoop.

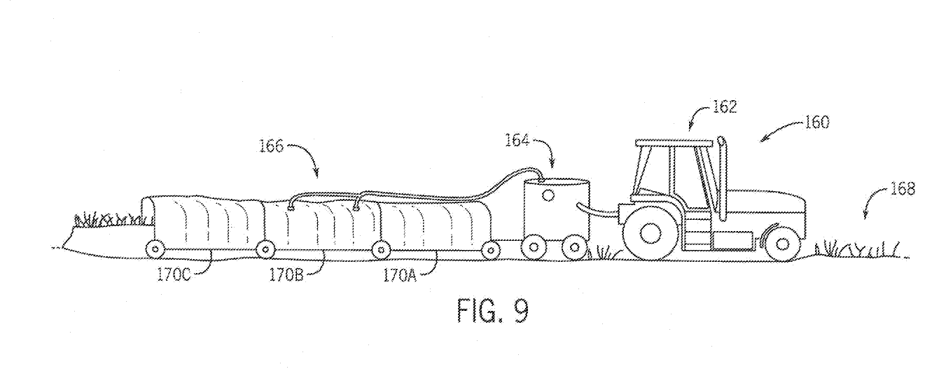

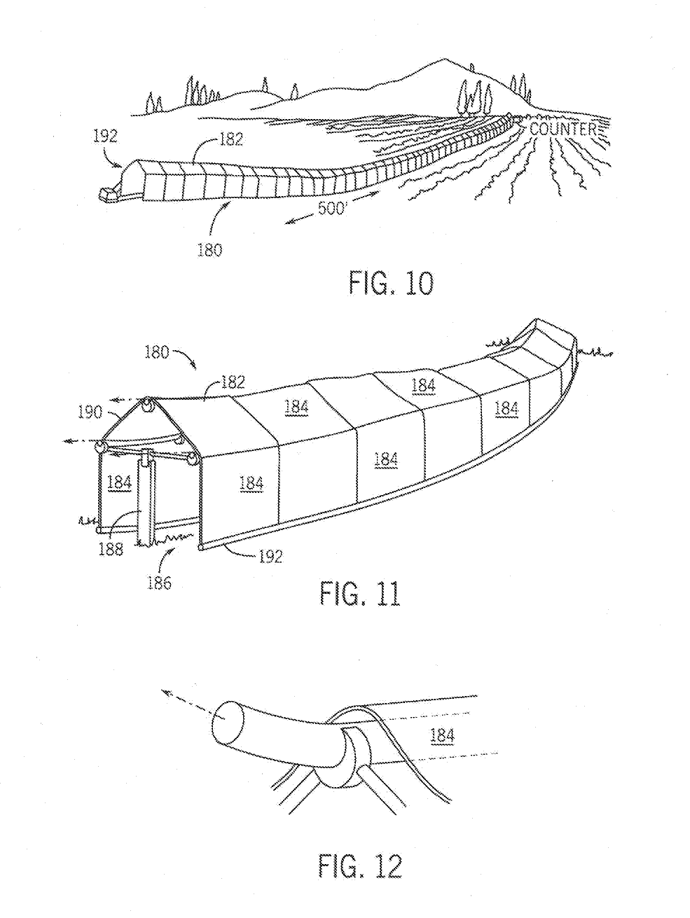

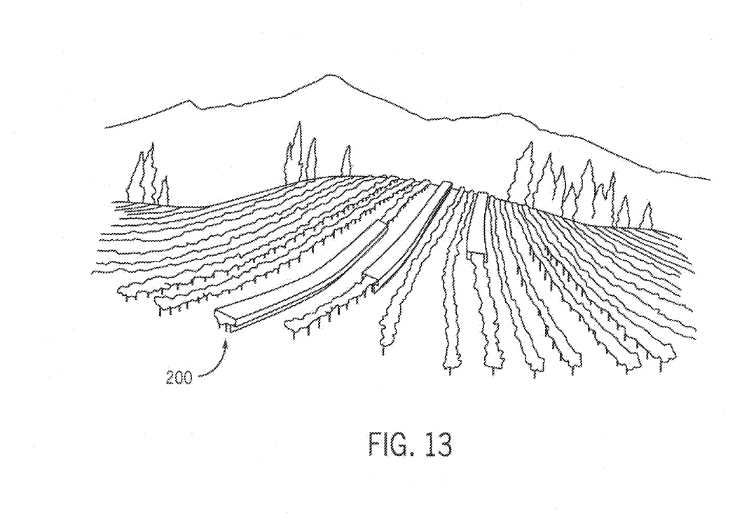

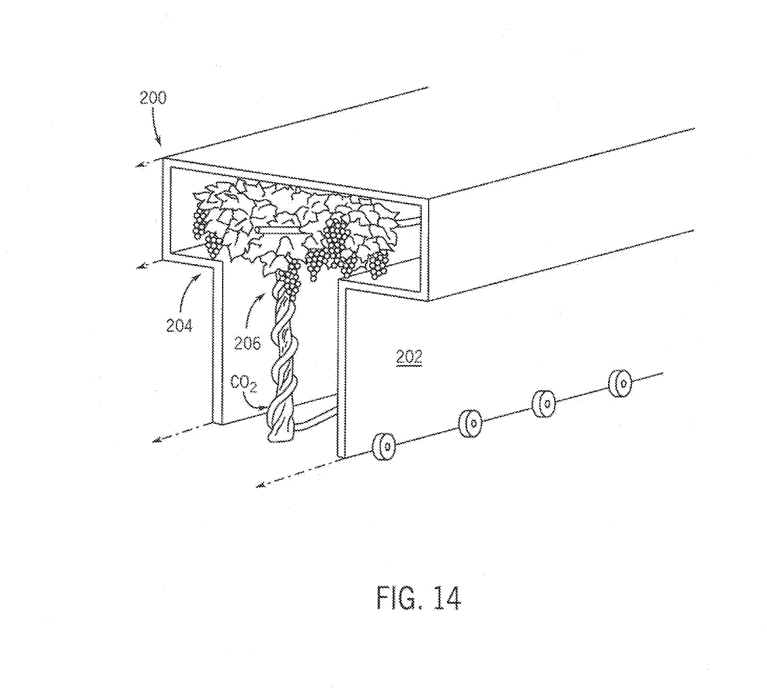

FIGS. 9-15 show details of one embodiment of the modular, canopy type emitter array 70, for example of system 40. FIG. 9 is an elevation view of the emitter array 70. The emitter array 70 is constructed and arranged to have a curvilinear canopy or umbrella-like configuration, with a central base 72 and at least two curvilinear, downwardly sloping arc or crescent-like arms 74 A-B. The base 72 is adjustably coupled to a stand (not shown). The base 72 has a central gas transportation lumen that communicatively connects with the supply line and a lumen of each arm 74. Arms 74 have a length such that they extend outwardly and downwardly over the canopy of the mature subject plant. Arms 74 are preferably constructed of interconnected modules, segments or sections 76 which are conjoined to each other, to form the full arm 74. The sections 76 are provided preferably in 12 inch lengths, resulting in arms 74 having a length variable from 2 to 6 feet in length. The sections 74 are preferably molded and constructed of plastic material. Each section 76 has at least one emitter element 78 for egress of gas. The emitter elements 78 may be apertures disposed in the arms 74 communicating the internal lumen of the arm 74 with the outside environment. Alternatively, they may be constructed in the form of a nozzle attached to the arms 74. As is best shown in FIG. 11, the nozzle 78 may be swivel able to direct gas emission downwardly or to the side. In non-modular wands, the apertures or nozzles are spaced at predetermined points along the length of the tubular wand body. A terminal member 80 is attached to the distal ends of the arms 50. FIG. 12 is a crossectional view of an embodiment of the array module, section or segment 76. FIG. 13 is an end view of the module 76. A deflector plate 94 is preferably connectible to the module 76 via a snap on type connection. Internally, a hollow screw 96 provides a lumen for gas to pass through at relatively high volume rates. Referring also to FIGS. 14 and 15 the screw 96 threads 98 create long, small channels to the emitter outlets 78, The pitch and depth of the external threads 98 permits variation of the gas flow rate. FIGS. 10 and 11 illustrate an embodiment of a connector 82 for use between emitter modules 76 in the arc type gas emitter 70. In cross section, the sections 74 are shown to have flow paths that are long which yields a relatively high back pressure which is used to control flow rate.

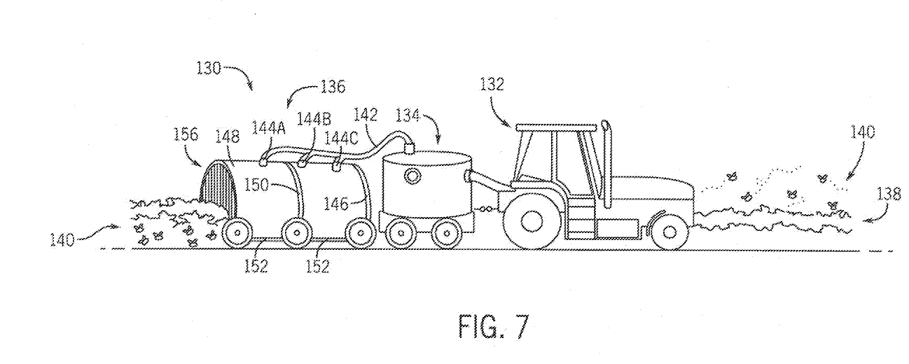

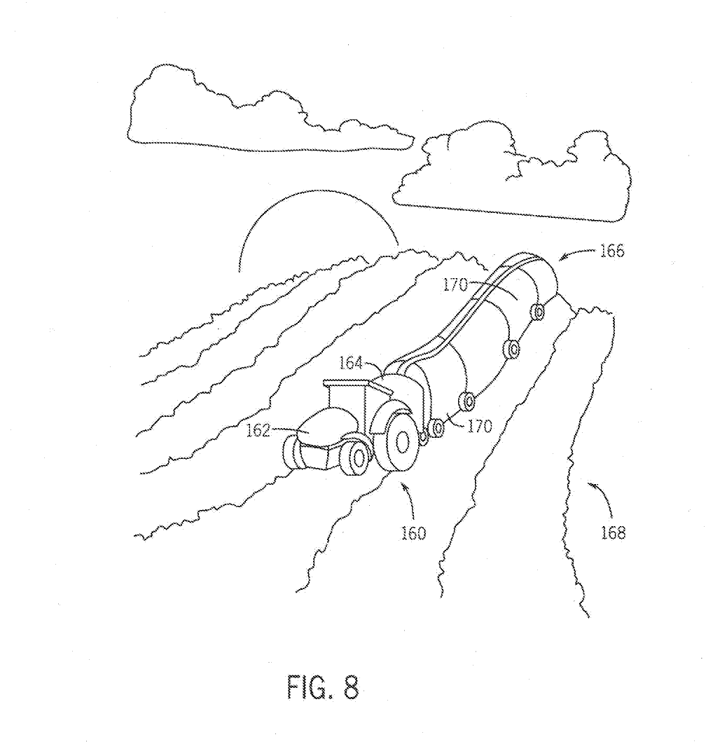

FIGS. 7 and 8 show a multi-stage embodiment of the gas distribution system 60 for use with a plurality of crops 62 growing in a field, plot, green house, hoop house 64 or the like. In a hoop house 64 deployment, crops 62, for example Cannabis, are grown in beds 66. Gas is supplied to the crops 62 via the wand type distribution system 10, the canopy type distribution system 40, or a combination thereof. Associated gas supply apparatus 68 is connected to the distribution apparatus 10/40. The systems 10/40 are raised as plants 60 mature from plantings, juvenile, and mature stage. At harvest, the system 10/40 is easily moved upwardly or sidewardly out the way, or removed entirely. The system 10/40 may then be quickly re-deployed for a new crop planting. As is best shown in FIG. 8, the multi-stage system 60 also preferably has drip tape type distributors including a bottom up distribution lower stage 1 tape 84 and an upper stage 2 tape 86. These stages 84 and 86 are supported on stands or stakes 92. Alternatively, they may be supported on conventional bed netting. They are connected to a gas supply 88 by respective valves 90A/B. Alternatively, a single tape may be deployed and raised as the plant grows. A top down crescent type distributor 40 is provided as a third stage. A fourth stage involves moving the distributor 40 upwardly as the plant grows. Valve 92 enables actuation of the top down third and fourth stages. This arrangement 60 permits limiting CO2 application height to a particular value, for example approximately 30 inches. In early stage plant growth, bottom up gas distribution is believed to be favorable. Top down distribution is believed to be favorable in later stage growth of mature plants.

FIG. 6 shows an embodiment of a swivel nozzle 100 which is useable with the gas distribution apparatuses described above. The nozzle 100 has a body 102 with one or more swivel able nozzles 102. This facilitates adjustment of gas spray direction. The nozzles 102 preferably have an on/off capability.

In general, growers are very knowledgeable about light. The invention minimize the shading/pipe size (i.e. spaghetti pipe). The system also provides agronomic function “trimming buds” (with pipe).

2. Mobile Gas Canopy System and Methods

The invention also provides a system for killing pest insects by sustaining lethal levels of gases for a short period of time surrounding the leafy canopy of crops such as Cannabis. The system is an integrated, mobile canopy and gas system. The system can towed behind a farm tractor or motorized farm implement or be self-propelled. The system and method can greatly reduce the untargeted killing of desirable honeybees and pollinators, while eliminating toxic chemicals from entering the human food supply chain, groundwater and the like.

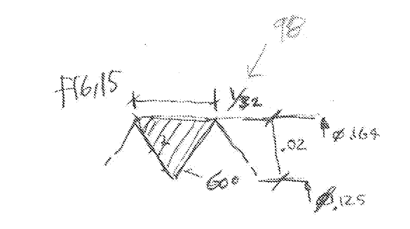

Referring to FIGS. 16 and 17, illustrate a first embodiment of a mobile gas canopy system 110 of the invention. The mobile gas canopy system 110 is useful for organic pest control for crops, particularly organically grown crops. The system 110 comprises an elongated mobile canopy 112, a mobile gas tank 114 containing liquefied CO₂ or other liquefied or compressed gases such as nitrogen, and propulsion means 116. In this embodiment the canopy trailer 112 and gas source 114 are securely hitched to a farm tractor 116 and towed down the length of the field covering a row of crops. The canopy trailer 112 has a forward or front entry or entrance end 118 and a rearward exit end 120. In this embodiment the canopy has a plurality of wheels 113 which permit it to be moved over a field of crops. FIG. 18 shows the rear exit end 124 of a modified embodiment of the wheeled trailer 122.

FIG. 19 illustrates another embodiment of the mobile gas canopy system 130 including a tractor 132 pulling an augmenting gas trailer 134, and a single, relatively short, wheeled gas canopy trailer 136. The system 130 is moving over crops 138 which have a pest infestation 140, in this case insects. Gas supply line 142 feeds gas from the supply 134 to gas injectors 144A-C. The canopy 136 has a soft flexible front entry 146. Canopy 148 is held by one or more supports 150 and includes a ground seal weighted flexible bladder 152. The trailer 136 has a soft, flexible end cover 154. Clean pest free crops emerge from the rear exit 154, the pests 140 being terminated.

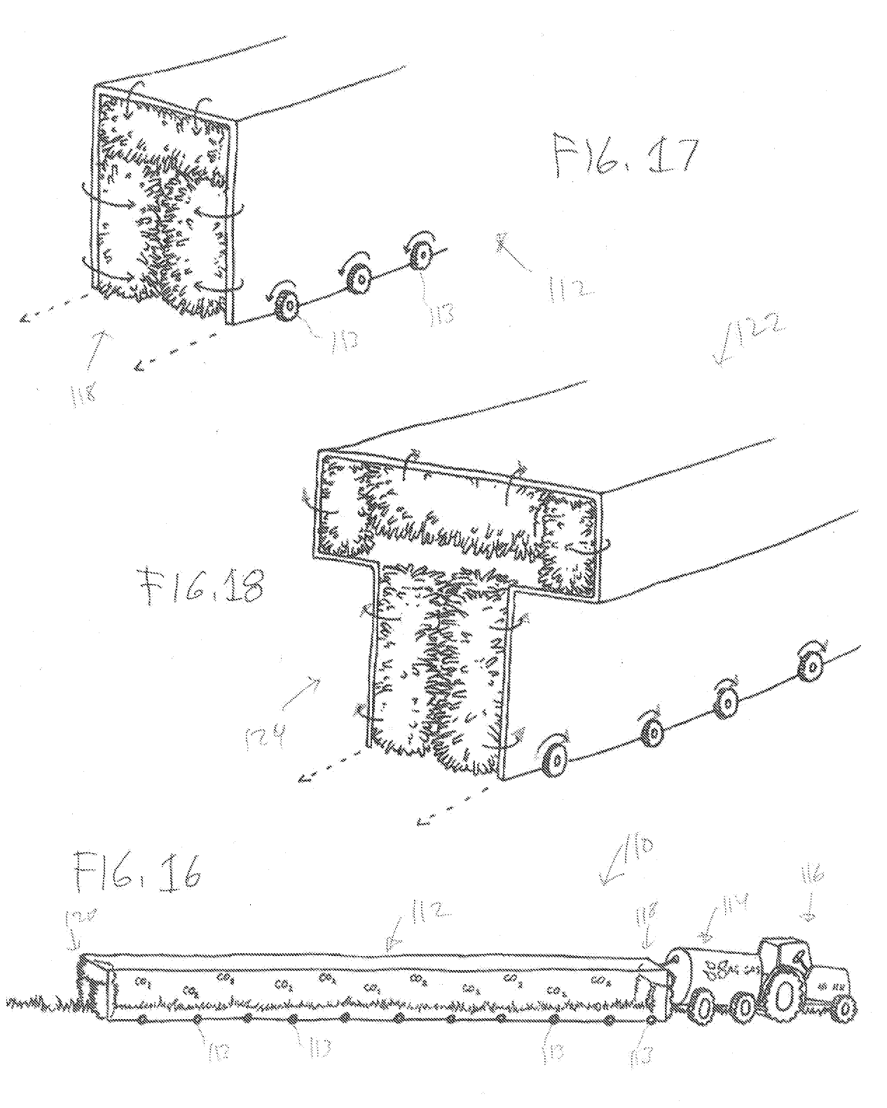

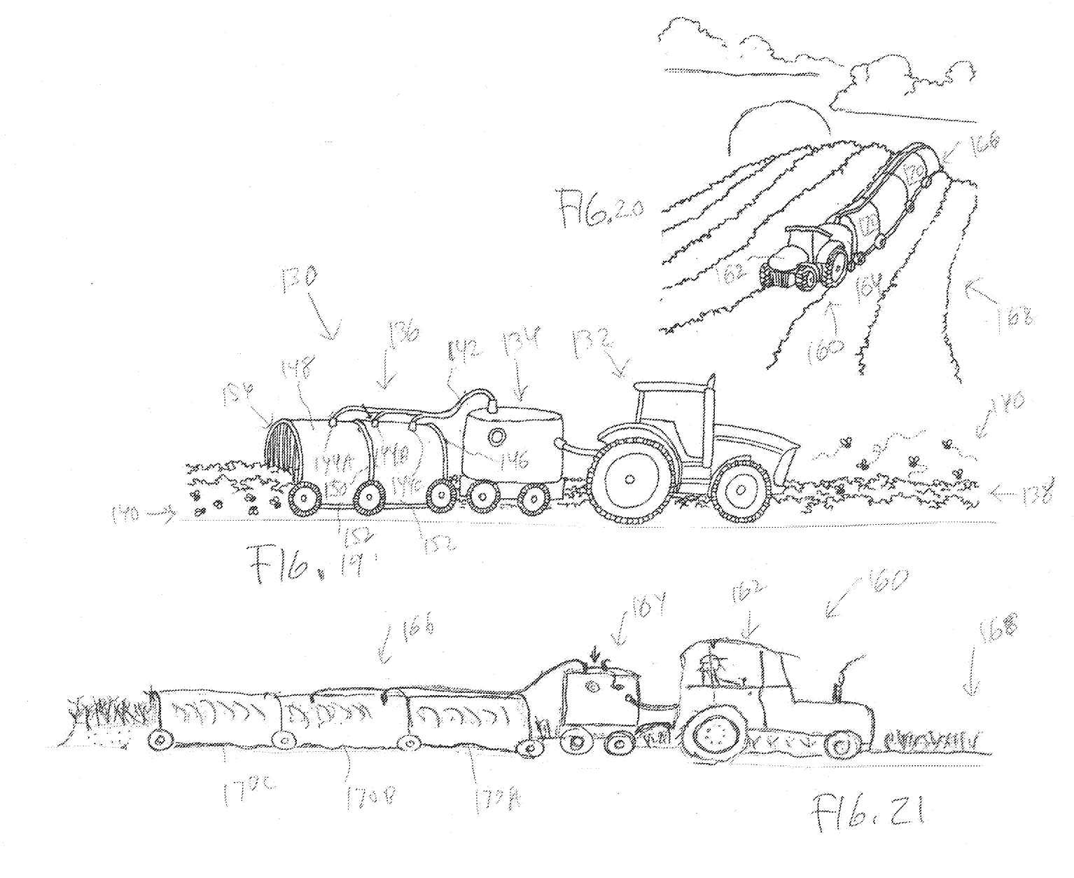

FIG. 20 illustrates a further embodiment of the mobile gas canopy system 160, in side elevation, including a tractor 162, a gas supply trailer 164, and a multi segment, wheeled gas canopy trailer 166. The canopy 166 includes a plurality of segments 170A-C FIG. 21 shows the system 160 in perspective, in operation in a sloping field 168 of crops. Multi-segment or modular construction permits adjustment of the length of the canopy.

Although the mobile gas canopy systems have been shown and described in connection with a tractor for propulsion, it is within the purview of the invention that they could be self propelled.

In general, the mobile gas canopy framework may be mounted on skids, wheels or tracks supports overriding light weight canopy, sidewalls, and front entrance and rear exit gates, isolating and enveloping a lethal (to pests) enclosure of gas. Downwardly depending sidewalls extend from an upper frame that is at least slightly taller than the height of the crop. The frame with canopy rides unencumbered and in close proximity over the top of and alongside a bed or furrow of crops without touching the plants except at the entrance and exit gates. The canopy is constructed from flexible fabric on a skeletal frame or alternatively from light weight rigid molded plastic or the like.

The wheels of the canopy 112/122/136/166 in embodiments 110, 130 and 160 in FIGS. 16-21 are spaced width wise to suitably ride and tow in the furrow or bed i.e., troughs between rows or beds. Desirably, the wheel spacing can be an adjustable width to adapt to multiple crops and bed width configurations. The enclosure canopy width spans at least one furrow or bed wide, but desirably can cover multiple rows for a single pass down the length of the field making it more efficient.

Frames may have dual top spines disposed on opposing sides in the upper half of the canopy structure give the section lengths of the canopy structure a straight rigid configuration when the spines are in their extended position; (hinge is straightened out or telescoped outwardly), and in collapsed accordion position when the two spines are folded up. If the height of the canopy height is for example 15′ tall for orchard crops, the spines can be located on the inside of the canopy and fold downwardly to 5 to 10″ and when extend the section reaches a length of 10-20′. When the canopy height is lower like for vineyards or field crops like tomatoes even lower still, the spines are located on the outside of the canopy and fold upwardly.

The gas canopy configurations may be constructed in rolling modules, such as in a railroad car configuration, that are hooked together to form a longer enclosure with accordion fabric completing the enclosure between modules; configuration can be similar to passenger railcars hooked together, or longer “dual” city buses that have an accordion fabric baffle interconnecting passenger railcars or bus sections. The modules may have accordion fabric interconnections afford the capability to turn corners at the end of the fields, while containing a weatherproof seal for the interior elevated gas concentration space. Canopy sidewalls are downwardly depending from a frame are flexible sides/slack allows the caterpillar like navigation to turn a corner without collapsing—then can turn a corner. The gas canopy is ostensibly sealed to the ground along the elongated length by weighted flexible “ground contact skirts” arranged to slither along the ground, conforming to the ground, and hence forming a relatively desirable level of a containment seal between the canopy and the ground containing the elevated gas inside the overriding canopy from escaping to the surrounding atmosphere. The ground contact skirts are constructed of durable, scuff-proof material, so they can drag on the dirt without undo wear and tear. Ground contact skirts, like the gas containment end gates can have a double seal system to provide a second containment seal with the ground on both sides. Canopy sidewalls are downwardly depending from a frame are flexible accordion sides/slack allows the “caterpillar type motion” to turn a corner without collapsing—then return to a straight configuration to proceed down the length of the field.

The invention further comprises a “slinky-type” feature at the end of the field rows that can ostensibly collapse from a very long length to a very short length giving the apparatus capability to make tight radius turns and for travelling down the highway and the likes. The overall width of the canopy can also collapse inwardly to allow for tighter radius turns and to safely and conveniently travelling down the highway in a single lane of traffic, versus dangerously wide farm implements that block the flow of traffic and are unsafe when travelling from field to field. Collapsibility is accomplished by hinged metal supports that are straight when fully deployed for length and width and “broken” hinged upwardly. The flexible canopy and design are such that the fabric doesn't drag on the ground during the collapsed mode and the ground contact skirts can also be lifted upwardly into a “Travel Position”.

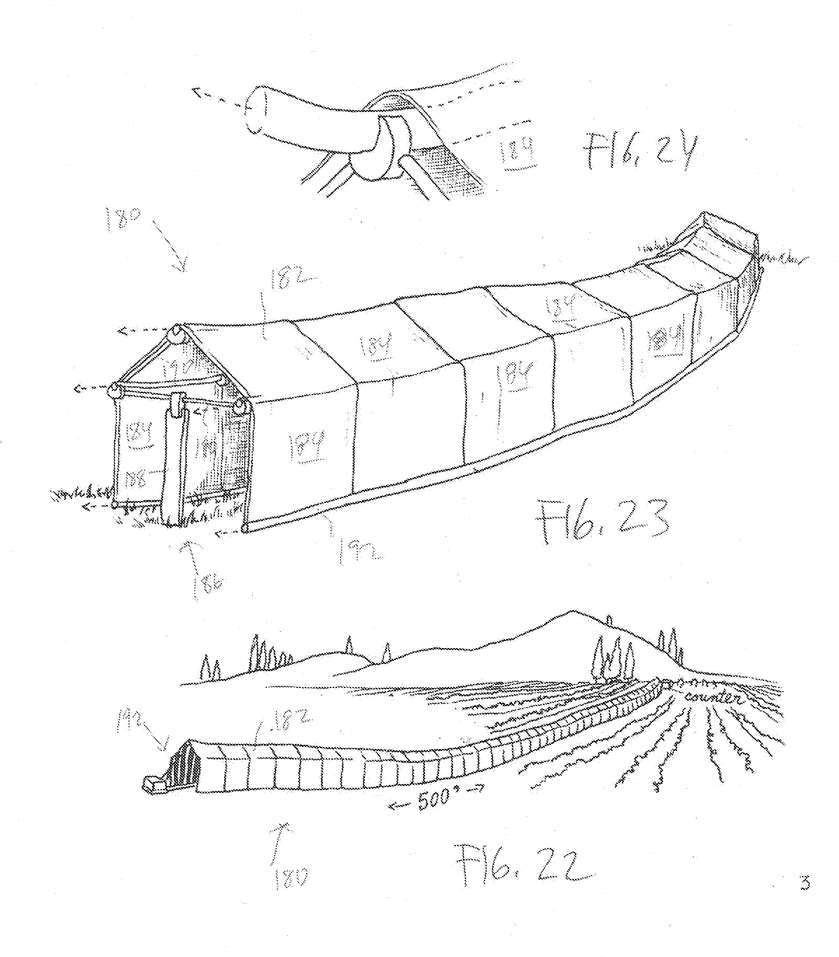

FIG. 22 illustrates a further embodiment of the gas canopy system 180 including a temporary, static, flexible (un-wheeled) canopy 182 disposed over rows of crops using a flexible material 184, such as fabric or sheeting supported by a frame 186 comprising, for example stanchions 188, support cables/ropes 190 engaging the stations, and deployable flexible cover 184. An end unit 192 is preferably constructed of a flexible polyester “spaghetti” type material which hangs over the ingress/egress portal to limit or prevent gas from escaping. A ground contact skirt 194 is deployed at the bottom perimeter of the canopy 182. FIG. 23 is a perspective view of the system of FIG. 22. FIG. 24 is a detailed view of a portion of the system of FIG. 23 with notches for structural support.

Rigid stanchions can be provided at intervals along the length of a row of vines, orchard trees or cannabis. The removable fixtures are spaced at intervals to adequately support deflection of cable and fabric above the crop canopy. The stanchions are located above the crop and to the outside of the foliar canopy so that fabric can be sufficiently draped over and to the outside of the foliar canopy on both sides creating a tenting effect. Slippery balls may be rigidly affix to the station to allow fabric to easily slither down the length of the row unimpeded and without ripping or tearing. The slippery balls can be constructed from Teflon, plastic or the likes and have a notch provided to accommodate support cable or rope down the length of the entire row. Cables and fabric can be pulled down/over the entire length of a row of vines, trees or cannabis. Mechanical mechanisms and counter weights can be provided at either end to provide adequate sturdy tension and support of the weight of the cable and fabric down the length of the field. Gas can be uniformly introduced to kill the pest and then the entire device can be moved to the next row and the process repeated. This configuration can work in conjunction with other AG Gas® systems.

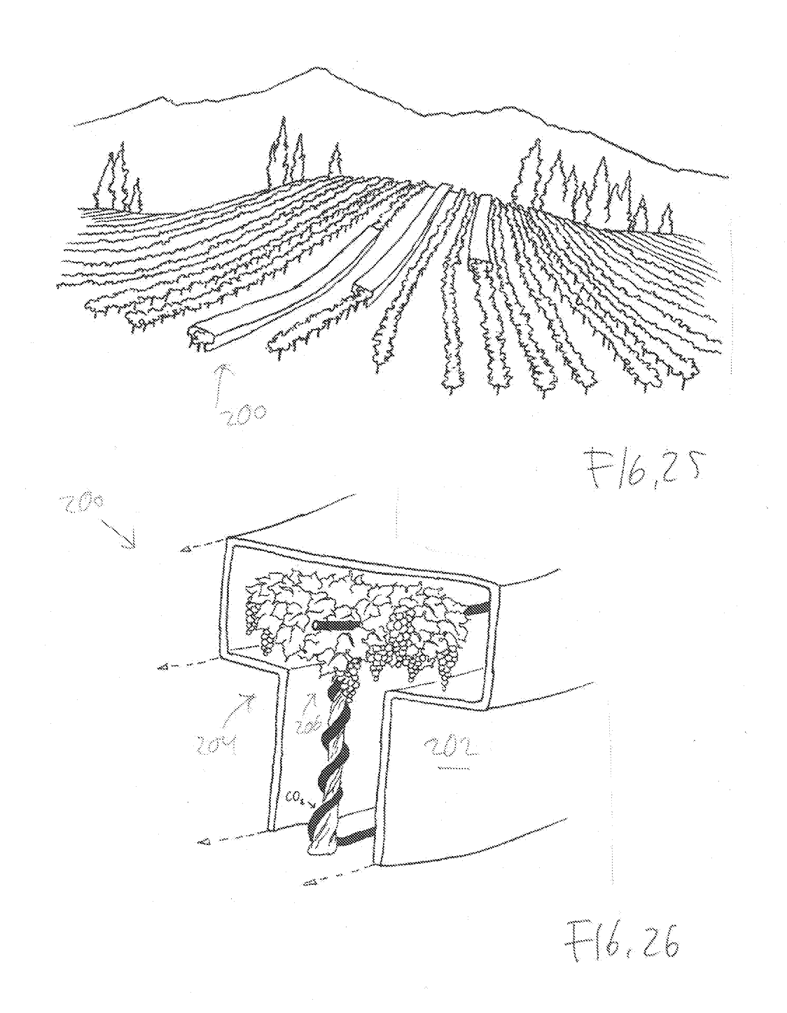

FIG. 25 illustrates yet a further embodiment of the system 200 deployed, statically and temporarily in a vineyard with sloping terrain. FIG. 26 is a perspective view of an end of the system of FIG. 25. A T-Shaped Canopy 202 has ingress/egress portals that are shaped to allow vines 206 to pass freely through the canopy 202 without damaging the crop 206.

In the static system embodiments 18 and 200 the ground contact skirts may alternatively be plowed into substantial contact with a dirt cavity and berm ostensibly formed by plowing, from the front leading, bottom-edge and following down the entire sidewall length of the forwardly progressing gas canopy, thus adding extra beneficial gas containment seal along both long sidewalls, employing furthered earthen contact.

In still another configuration which is useful with strawberries whose production employs very highly raised beds and deep walking furrows, the sidewall sealing contact can be accomplished along the sidewall of the raised bed.

Both the entrance and exit gas gates are designed to contain elevated gas levels inside the enclosed canopy and minimize gas from escaping into the surrounding atmosphere. In the preferred embodiment the entrance and exit gates are specifically shape to the configuration of the crop's agronomic architecture. For example, grape vines are narrow on the vertical bottom and have “shoulders” formed by the trellising forming the familiar “T-shape” of vineyard rows the canopies entrance and exit are shaped to a “T” to allow the crop to pass gently into the canopy and out of the canopy without damaging the crop. Orchard rows are shaped to orchards' row shape/architecture of the end profile. Row crops like tomatoes or peppers the canopy just rides freely over the beds' and crops' architecture.

In both mobile and static embodiments, flexible poly “spaghetti” may be deployed to hang down to further seal the elevated gas from escaping, the poly spaghetti helps seal the crop inside but doesn't damage the crop as the vehicle passes over the crop at the entrance and exit. Gating may have top down fabric spaghetti or sideways extending fabric soft “brushes”.

In an alternative gas gating entrance and exit, the end enclosures whose purpose is to contain high levels of gas enrichment in the interior space, as crops pass into the front opening and out of the rear opening of the enclosure, can be at least one rotating spindle similar to in an automated carwash only with much slower rotation speeds and self-supporting erected outwardly depending spines These spindle gas gates have flexible soft spines. The speed of rotation of the spindle would be geared calibrated to engage the plants/crop at the same rate as the forward rate of motion of the gas canopy through the field. If forward movement stops, the rotation of the gas gates stops. When forward motion resumes, rotation resumes and at an equal pace. The direction of rotation is inwardly providing for the crops to gently pass into the interior space. The purpose of the rotating gating doors is to engage the crop with the least amount of damage to the plants, gently passing the crop into the interior of the canopy at the front end and equally gently ejecting the crop out the rear end of the canopy, while providing the maximum amount of gas retention inside the gas canopy. One desirable rotating gate configuration is two vertical axis one on either side of the crop canopy that engage the sides of the crop and one horizontally axis engaging the top of the crop. There can be several configurations to best engage a crop, i.e. orchards are different than vineyard are different than field crops like tomatoes, peppers or strawberries. Multiple, entrance and end gates can be in sequence administered to multiply the gas seal capability at the end of the elongated gas canopy containment structure, i.e., have more than one gas gate on each end, improves the gas retention and lethal concentration within the interior of the enclosure and reduces the loss of gas to the surrounding ambient environment.

Depending on the forward motion cadence of the gas canopy, i.e., Incremental vs Continuous forward movement; entry and exit gating doors may open and close or have shutters if the forward movement is incremental starting and stopping over individual plants or sets of plants. This incremental movement could be employed on such crops as outdoor cannabis. With incremental motion the doors can be rigid. The canopy can shunt forward over a set of plants. The end doors can close forming a sealed environment and the lethal dose of gas can be administered. The doors can then reopen and the canopy is shunted forward over another set of plants to repeat the process. The forward speed of the device and a function of the length of the enclosure allows a duration of time measuring the time from when the plants enter the enclosure to the time the plants exit the enclosure is long enough relative to the gas level maintained within the enclosure is sufficient to render pests economic impact.

Further a supply line of gas is provided form the tank to injectors located toward the middle of the elongated canopy. The injectors maintain a lethal and sub lethal concentration of gas throughout the length of the enclosure, with some tapering off of concentration near the entrance and end caps where dilution occurs with the exterior atmosphere condition. Gas is provided to the canopy by a mobile tank on a trailer towed by the tractor, or through a fixed gas supply line located at one end of the field and a connecting flexible gas supply trunk line that can be a retractable hose serviced from the end of the field.

The method of the present invention includes a calculated concentration of gas, duration to kill the bugs and pest at said concentration, overall length of the modular canopy, rate of speed of the forward movement over the top of the crop, and length of the dilutive zone “tapering off of gas concentration” at the front and rear of the canopy. The method calls for a “Kill Zone” that at a forward pace of speed is over the bugs for a long enough period of time to get a high percentage kill ratio on the targeted pests.

For more constrained and limited indoor greenhouse applications, or the likes, a fully telescoping accordion capability is desirable. An engine free version can be used indoors in greenhouse style operations and elongated over the bed, one at a time, from bed to bed. This embodiment of the invention is accordion retractable and then wheeled into position at the end of the next bed over the crop such as in the production of Cannabis.

An embodiment of the method of the invention includes the use of lethal gas application at night, so that no pollinators are killed, like honeybees that return to their hives in the evening to roost and don't return until it warms up in the morning. In this desired method the lethal gas application stops when the pollinators return around sunrise for their daytime pollination duties. And, there is no toxic chemicals residue left behind to indiscriminately kill the pollinator species. Further, the current invention precludes toxic chemical pesticides from entering the human food chain, or pollution of groundwater and the likes.

While the current invention is applicable to a wide variety of crop types, it has particular benefit on mandarin oranges. During the flowering season some 16,000 acres of mandarin oranges in California are covered with pollinator nets. The netting is deployed over the rows of trees continuously to keep the honeybees and other pollinators away from the flowers, so that the fruit is borne desirably seedless, i.e. un-pollinated. During the 60 days that the large fields of mandarin oranges have the nets on, the pest control managers “lose control”, that is they cannot spray insecticide outbreaks inside the nets with chemical agents. Aphids, red scale and thrips can do much damage to the crop during this time when the nets are deployed and the is no control of pest outbreaks. Desirably the current invention can be deployed over the outside of the nets and the gas easily and quickly migrates into the foliar canopy killing the pests, thus giving the pest control managers an important tool to restore pest control even when the netting is deployed.

The method of killing pests may be performed with the function with one row/bed of application overlap to reduce insect migration flight or “crossing over” of pest from a treated to untreated set of plants of the field.

Applicants hereby incorporate by reference the disclosures of the following US Patent Applications:

Title: INTEGRATED, SELF SUPPORTING ELEVATED GAS DELIVERY TUBE AND LED LIGHT FOR CROP FOLIAGE

### Application No. 62/367,276

### Filing Date: Jul. 27, 2016

Title: GROUND TO CANOPY GASEOUS MEDIA DELIVERY SYSTEM FOR CROPS INCLUDING LEAK DETECTION AND HOOK AND WAND FEATURES

### Application No. 62/403,800

### Filing Date: Oct. 4, 2016

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. An agricultural system for distributing gas to a plant set having one or more plants, comprising at least two supports adapted to be place adjacent the plant set, at least one elongated gas wand having a predetermined length such that it engages two supports so that it is supported, adjustably with respect to height, adjacent the plant set, the at least one gas emission wand having a tubular body with a gas transmission lumen and at least one gas emitter element disposed on or in the body for egress of gas from the gas transmission lumen to the environment adjacent the plant set.

2. The system of claim 1, wherein the gas is CO2, and wherein the plant set consists of Cannabis.

3. The system of claim 1, wherein each support comprises at least one vertical member adapted to be place on or in soil and a mesh panel coupled to the at least one vertical member and held adjacent to the plant set so that a plane of the mesh panel is parallel to the major vertical axis of the plant set, the mesh panel having at least 3 vertically oriented mesh apertures, whereby the gas wand may be selectively placed in one mesh aperture to adjust the height of the gas wand.

4. The system of claim 3, wherein the support comprises two vertical members and wherein the mesh panel is coupled to two vertical members and is disposed between the two vertical members to which the mesh panel is coupled to.

5. The system of claim 4, wherein there are three or more supports spaced around the plant set.

6. The system of claim 1 wherein there are a plurality of gas wands, the wands being selectively coupleable and held to the at least one support to adjust the amount and orientation of gas distribution to the plant set.

7. The system of claim 1, wherein the gas wand comprises a plurality of elongated body modules, the modules being connectible and disconnectible to each other to adjust the length of the gas wand, each body module having a body member having connectible ends and a central lumen.

8. The system of claim 1, wherein the gas emitter element is an aperture in the gas wand body.

9. The system of claim 1, wherein the gas emitter element is a nozzle connected to the gas wand body.

10. The system of claim 1 wherein the gas wand has a gas supply connector disposed at one end which is adapted to be connected to a gas supply.

11. The system of claim 1, wherein the gas wand has a support connector at one end which is adapted to couple and de-couple to the at least one support.

12. An agricultural system for distributing gas to a plant set having one or more plants, comprising an elongated vertical support having a predetermined height and adapted to be placed in close proximity to the plant set, an emitter array selectively coupleable to the support so that it is supported, adjustably with respect to height, above the plant set, the emitter array having a base which engages the support and a plurality of arms which extend radially away from the base, the base and the arms each having a coextensive gas transmission lumen, each arm having at least one gas emitter element which is communicatively connected to the gas transmission element for egress of gas from the gas transmission lumen to the environment adjacent the plant set.

13. The system of claim 12, wherein the plant set is Cannabis and the gas is CO2.

14. The system of claim 12 wherein the arms have a curvilinear aspect whereby the arms extend downwardly in an arc.

15. The system of claim 12, wherein the arm comprises a plurality of elongated body modules, the modules being connectible and disconnectible to each other to adjust the length of the arm, each body module having a body member having connectible ends and a central lumen.

16. The system of claim 12, wherein the gas emitter element is an aperture in the arm.

17. The system of claim 12, wherein the gas emitter element is a nozzle connected to the arm.

18. The system of claim 12 wherein the gas wand has a gas supply connector disposed at one end which is adapted to be connected to a gas supply.

19. An agricultural system for distributing gas to a plurality of plants growing in rows, comprising an movable gas canopy for enclosing at least one row of plants and along a predetermined length of the at least one row of plants, the canopy having a predetermined height which is greater than the height of the plants and a predetermined width which is greater than the width of the row defining an interior space for enclosing the plurality of plants, the canopy having an entrance end and an exit end which permit movement of the canopy along the row, and a gas supply means for supplying gas to the interior space.

20. The system of claim 19, further comprising means to propel the gas canopy along the at least on
